(19) United States
(12) Patent Application Publication
(10) Pub. No.: US 2010/0179691 A1
(43) Pub. Date: Jul. 15, 2010

(54) Robotic Platform

(75) Inventors: Ehud Gal, Reut (IL); Gennadiy Berinsky, Modi'in (IL); Yosi Wolf, Tel Aviv (IL)

Correspondence Address: MARSTELLER & ASSOCIATES, P O BOX 803302, DALLAS, TX, 75380-3302, US

(73) Assignees: WAVE GROUP LTD., Tel Aviv (IL); O.D.F. OPTRONICS LTD., Tel Aviv (IL)

(21) Appl. No.: 12/598,729

(22) PCT Filed: May 1, 2008
(86) PCT No.: PCT/IL08/00585

§ 371 Date: Mar. 25, 2010

(30) Foreign Application Priority Data
May 6, 2007 (IL) 183006

(51) Int. Cl. G05B 15/00

(52) U.S. Cl. 700/259

(57) ABSTRACT

The present invention is a robotic mobile platform vehicle that can be thrown into hostile or hazardous environments for gathering information and transmitting that information to a remotely located control station and a system comprising the robotic mobile platform. The system of the invention is adapted to provide it's operator with significant information without being exposed directly to actual or potential danger. One of the key features of the invention is that at least four imaging assemblies are mounted on the robotic platform and that the system has the processing ability to stitch the views taken by the four imaging devices together into an Omni-directional image, allowing simultaneous viewing of a 360 degree field of view surrounding the mobile platform. Another feature is that the system comprises a touch screen GUI and the robotic mobile platform is equipped with processing means and appropriate software. This combination enables the user to steer the robotic platform simply by touching an object in one of the displayed images that he wants to investigate. The robotic platform can then either point its sensors towards that object or, if so instructed, compute the direction to the object and travel to it without any further input from the user.

### FIELD OF THE INVENTION

The present invention relates to the field of robotics. More particularly, the invention relates to remotely controlled robotic platforms capable of operating in and gathering information from hostile of dangerous environments.

### BACKGROUND OF THE INVENTION

There are known many different types of remote controlled robotic platforms that can be sent to perform tasks in areas that are inaccessible or too dangerous for humans to operate in. These robotic platforms have operational capabilities that are used, for example, for gathering information, photographing, disarming bombs, repairing damaged equipment, etc.

The quality and price of these platforms depend on their capabilities, i.e. the equipment they carry and other factors such as: how durable they are in field conditions, how resistant they are to environmental conditions, and their navigability.

Many of the prior art robotic platforms are designed to operate only on relatively smooth surfaces and are likely to tip on their side and become inoperable on rocky ground, when crossing ditches, etc. Examples of robotic platforms that are designed to overcome this problem are described, foe example in U.S. Pat. No. 6,263,989 and U.S. Pat. No. 7,011,171. In U.S. Pat. No. 6,263,989 is described a robotic platform with 2 tracks and 2 additional robotic arms with tracks on each arm. The invention enables the platform to drive with either side up and to turn over to a preferred side. The robotic arms assist the robotic platform by being able to turn it over, if necessary, and to overcome obstacles and even to climb stairs. The robotic platform described in U.S. Pat. No. 7,011,171 comprises two independently moving sides, each having two wheels on its outer side. The two sides are connected by a central axle hub. A tail boom is attached to the central axis hub. The tail boom serves two functions, firstly sensor, such as a camera are attached to it to elevate them above the ground for a better view, and secondly the tail boom can be activated to flip the platform over if necessary and to enable the platform to climb stairs.

For many missions, e.g. surveillance within a compound entirely surrounded by a high wall or in a tunnel complex that can be entered only through a vertical shaft, it is not possible or practical to approach the area, place the robotic platform on the ground and have it advance into the area to carry out its mission. Solutions to this problem are provided for example in International Patent Applications WO 03/046830 and WO 2006/059326 by the same applicant, the descriptions of which, including publications referenced therein, are incorporated herein by reference.

In WO 03/046830 is described a device housed inside a durable spherical structure, designed for deployment by throwing it into potentially hazardous environments, enabling omni-directional view to those environments without endangering the viewer. The device is capable of acquiring and transmitting still or video images and audio streams to a remote, control and display unit located near the operator. Among the typical uses for such a device are: security and surveillance, search and rescue operations. In WO 2006/059326 is described a reconnaissance system designed to be shot by a rifle towards a target, stick into the target and to transmit imagery and other data from the target area. In both of these publications, however the device described does not include a robotic platform and therefore provides information only from and in the area immediately surrounding the location at which it lands.

It is a purpose of the present invention to provide a robotic platform equipped to allow omni directional observation and to gather and transfer information, to a user at a remote location.

It is another purpose of the present invention to provide a robotic platform, which can be thrown or dropped into a hostile and hazardous environment.

It is another purpose of the present invention to provide a robotic platform having the capability of operating in hostile and hazardous environments for a significant amount of time.

It is a further purpose of the present invention to provide a robotic platform, which can be can be navigated easily and with a high degree of accuracy.

Other objects and advantages of the invention will become apparent as the description proceeds.

### SUMMARY OF THE INVENTION

In a first aspect the invention is a remote controlled robotic platform outfitted for gathering information from a hostile or dangerous environment and transmitting the information to a remote control station. The robotic platform comprises:
a) a body, comprising a hollow box;
b) at least four imaging assemblies at least one of which is located on each side of the body;
c) one or more additional sensors;
d) a communication assembly comprising a transmitter and a receiver;
e) onboard computing means comprising dedicated software and memory means;
f) a drive sub-system comprising four drive wheels, at least one reversible electric motor, and a gear train; and
g) a power supply for supplying DC electrical power to the components of the robotic platform;
h) wherein the robotic platform is designed and built to enable it to be thrown or dropped into the hostile or dangerous environment.

In preferred embodiments of the robotic platform of the invention, the drive sub-system comprises two tracks, each track fitted tightly over the pair of drive wheels on one side of the robotic platform.

The additional sensors placed on the robotic platform can be one or more of the following: video cameras mounted on PTZ mechanisms, sound sensors, volume sensors, vibration sensors, temperature sensors, smoke detectors, NBC (nuclear, biological, chemical) sensors, moisture detectors, and carbon monoxide sensors. One or more of the following components may be on the robotic platform: illumination means, laser target marking system, robotic arm, elevating means that enable elevating sensors above the top surface of the body of the platform, digital compass, and GPS system.

In preferred embodiments of the robotic platform of the invention, the symmetry of the robotic platform, including the placement of imaging devices and sensors, enables the robotic platform to perform its mission with either side up. Embodiments of the robotic platform comprise a mechanism which enables the platform to be propelled forward, for the purpose of assisting the platform to overcome obstacles in its path. In preferred embodiments the onboard computing means is configured to use multiplexing technology to handle the data received from the sensors and communication too and from the platform.

In a second aspect the invention is a system for gathering information from a hostile or dangerous environment. The system comprises: one or more robotic platforms according to the first aspect of the invention, one carrying case for each of the robotic platforms, and a remote control station.

The carrying case of the system of the invention is adapted to:
a) make it easy to carry while traveling to the site of the mission;
b) to protect the robotic platform while traveling to the site of the mission;
c) to be easily thrown into the observation area; and
d) to protect the robotic platform from damage caused by impact with the ground or other objects when thrown into the observation area.

Embodiments of the carrying case of the invention comprise a communication unit, which acts as a relay station, relaying messages between the remote control station and the robotic platform.

The remote control station of the system of the invention comprises:
a) a transmitter for transmitting commands;
b) a receiver for receiving data from the robotic platform;
c) a processing unit;
d) software that enables advanced image processing and information handling techniques;
e) memory means to allow storage of both raw and processed data and images; and
f) a display screen for displaying the images and other information gathered by the sensors on the robotic platform.

The processing unit of the control station and the on board processor of the robotic platform are configured to work in complete harmony. The processing unit of the remote control station and the on board processor of the robotic platform are supplied with software that enables some or all of the following capabilities:
a) stitching together the views taken by the four imaging devices into an Omni-directional image;
b) processing images by the use of an automatic Video Motion Detection (VMD) program;
c) the ability to sort objects in the images into general categories;
d) the ability to identify specific objects by comparison of the objects in the images with an existing database;
e) the ability to combine the image processing software with Optical Character Recognition (OCR);
f) the ability to recognize the sky lines in the images taken by the imaging sensors to compare them with a prepared sky line database thus being able to calculate the location of the platform; and
g) the ability to control two or more robotic platforms using one remote control station.

In preferred embodiments of the system of the invention, the display screen is a graphic user interface (GUI), which is configured to enable the user to control and navigate the robotic platform by means of appropriate GUI buttons on a control bar and input means.

Preferably the interface is a touch screen, which configured to enable the user to choose the manner of displaying the information from various options, depending on the requirements of the mission and his personal preference, simply by touching the appropriate icon on the screen; and to plan the mission and navigate the robotic platform simply by touching locations of interest in the images displayed on the interface.

The images displayed on the touch screen can be one or more of the following:
a) real time images from the observation area;
b) real time images from the observation area integrated with images from previous missions in the same area;
c) aerial photographs of the observation area;
d) real time images integrated with aerial photographs of the observation area;
e) graphical maps; and
f) topographical maps.

The remote station can be a dedicated unit, a laptop PC, or hand-held personal digital assistant.

In a third aspect the invention is a method of using the system of the second aspect of the invention for gathering information from a hostile or dangerous environment. The method of the invention comprises the steps of:
a) placing a robotic platform according to the first aspect of the invention into a carrying case;
b) carrying the carrying case to the boundary of the environment;
c) throwing the carrying case into the environment;
d) activating the drive sub-system of the robotic platform to drive the robotic platform out of the carrying case;
e) activating the imaging sensors and other sensors on the robotic platform to gather the information while navigating the robotic platform along a chosen path within the environment.

### BRIEF DESCRIPTION OF THE DRAWINGS

In the drawings:

FIG. 1 is a perspective view showing the main components of the basic embodiment of the robotic platform of the present invention;

FIG. 2A and FIG. 2B schematically show perspective views of embodiments of the carrying case of the system of the present invention;

FIG. 3 illustrates a typical scenario showing how the system of the invention is used to perform a mission;

FIG. 4 shows one embodiment of the graphic user interface (GUI) of the remote control station of the invention; and

FIG. 5 schematically shows an embodiment of the present invention in which the user controls two or more platforms using one control station.

### DETAILED DESCRIPTION OF PREFERRED EMBODIMENTS

The present invention is a robotic mobile platform vehicle that can be thrown into hostile or hazardous environments for gathering information and transmitting that information to a remotely located control station and a system comprising the robotic mobile platform. The system of the invention is adapted to provide it's operator with significant information without being exposed directly to actual or potential danger.

The present invention can be used by army combat units, army intelligence units, police and security forces, fire fighters, investigation units, etc. The system can be used for fighting terrorism, collecting real time tactical battlefield information, in hostage situations, etc. With appropriate modifications, the system of the invention can be used for civilian purposes, for example inspecting for leaks of hazardous substances at industrial or regional facilities where nuclear, biological or chemical materials are manufactured, used, or stored, by private investigators, and even as a smart toy for children and adults.

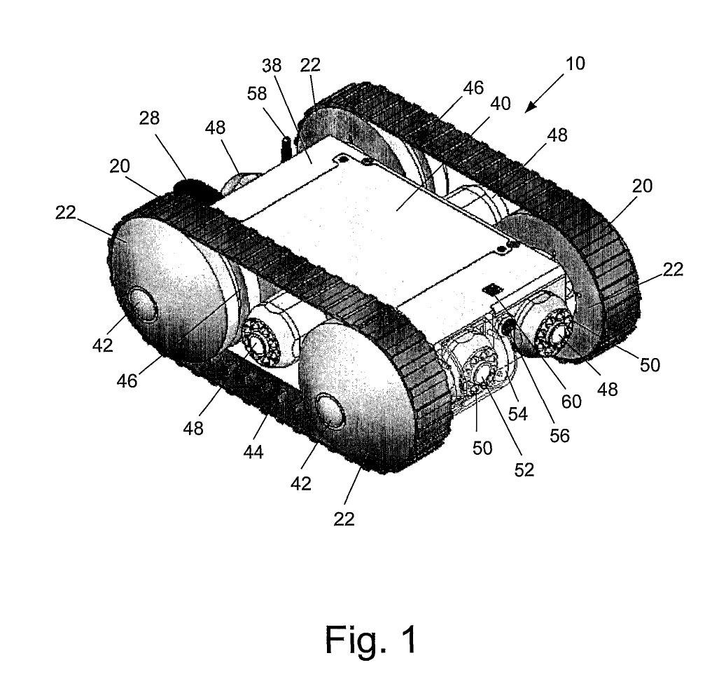

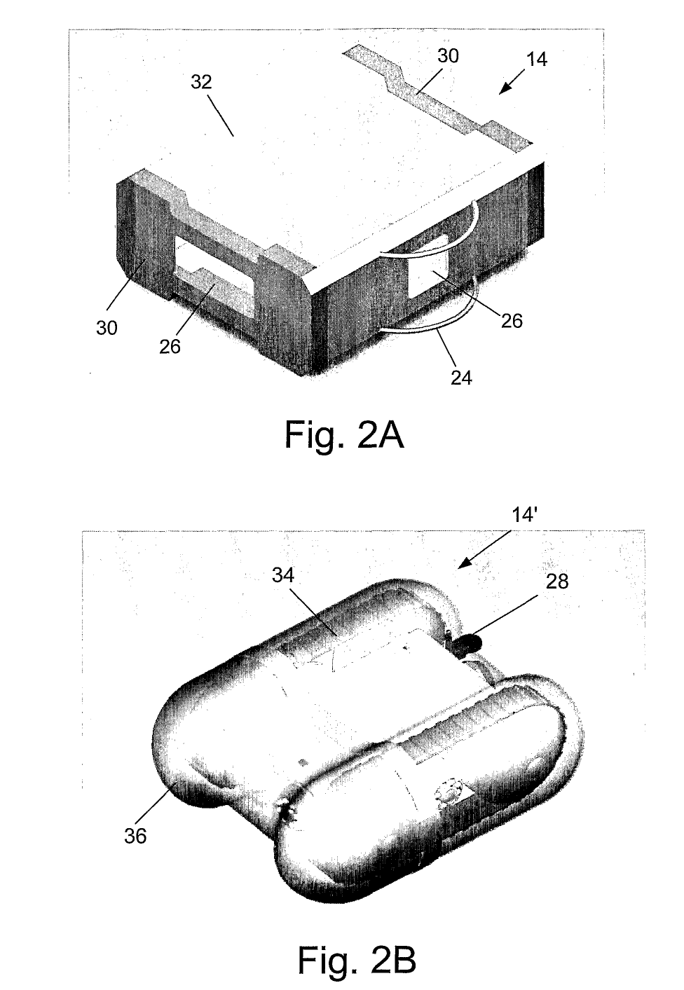

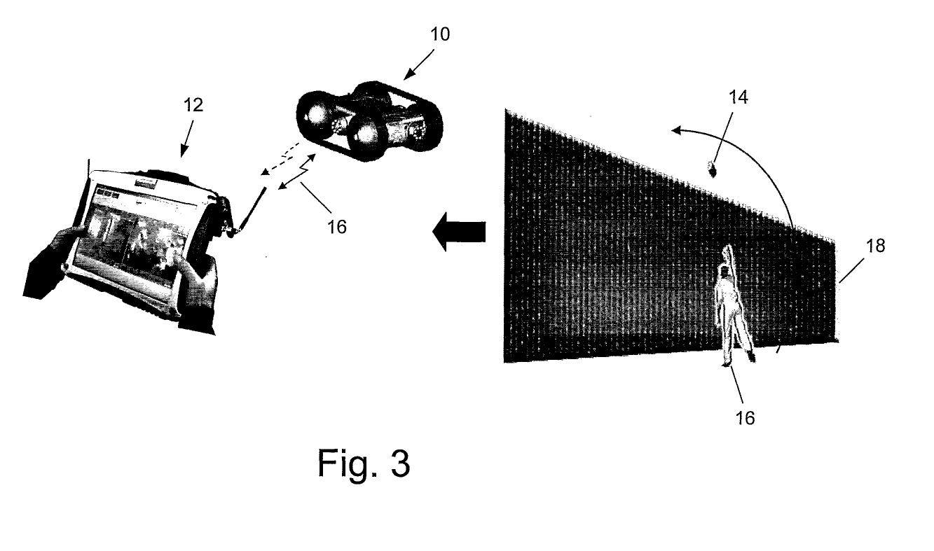

FIG. 1 is a perspective view showing some of the main components of the basic embodiment of the robotic platform system of the present invention. The robotic platform system is comprised of three main components: one or more robotic platforms 10, a control station 12 (FIG. 3), and a dedicated carrying case 14 (FIG. 2A and FIG. 2B) for each of the robotic platforms. The function of the robotic platform is to support imaging devices and/or sensors and/or other components and to move them around from place to place within the borders of the observation area in order to carry out the mission. The function of the carrying case is to protect the robotic platform and make it easy to carry while traveling to the site of the mission, to enable the platform to be easily thrown into the observation area, and to protect the robotic platform and the components that it carries from damage caused by impact with the ground or other objects when thrown. The function of the control station is to provide an interface between the user of the system and the robotic platform and components it carries allowing instructions to be sent and data to be received.

The robotic platform of the invention is designed to be thrown into a hostile or hazardous environment mainly for purposes of observation and reporting back its observations to the user. FIG. 3 illustrates a typical scenario showing how the system of the invention is used to perform a mission. The system user/operator 16, a soldier in this scenario, carries the platform inside dedicated carrying case 14. Soldier 16 approaches wall 18, which surrounds the area to be reconnoitered. He throws case 14 with the robotic platform inside, over wall 18 into the observation area. Once the case lands on the ground, communication 16 is established between the robotic platform 10 and the remote control station 12 and the robotic platform exits the carrying case and begins its mission as will be described herein below. After the carrying case 14 is thrown, it can not be predicted on which side it will land. Therefore carrying case 14 is designed, e.g. has convex side portions, to encourage it to come to rest on the ground/floor such that both tracks 20 of robotic platform 10 will be in contact with the ground/floor when it exits the case. This however does not guarantee which side of the robotic platform will be facing up and which will be facing down. To overcome this problem, the design of the robotic platform 10 of the present invention, including the placement of imaging devices and sensors is designed as much as possible to be symmetric with respect to a plane passing through the center of axles 42 of the four drive wheels 22 (FIG. 1), thereby allowing robotic platform 10 to perform its mission with either side up.

FIG. 2A and FIG. 2B show two embodiments of the dedicated carrying case 14 and 14′ of the system of the invention. Embodiments of carrying case 14 have different shapes that allow the case to blend into its surroundings in order to, reduce the chances of its being discovered, which, amongst other consequences, could trigger a search for and possible destruction of the robotic platform. For example carrying case 14′ shown in FIG. 2a, is roughly in the shape of a cement building block, making it appropriate for use on a building site; carrying case 14 shown in FIG. 2B has rounded, more naturally shaped edges making it suitable for use in open fields. The outer surface of the case can be textured, painted, or at least partially covered with camouflage net, etc. to help it to blend into the natural surroundings. The case is made from any material known in the art, e.g. a rigid elastomeric material, plastic, or metal such as aluminum, that will at the minimum meet the following criterion: The carrying case must be strong enough not to break on impact when thrown, or dropped from the ground, or even when dropped from a flying platform, e.g. a helicopter or an unmanned surveillance aircraft. In addition the traveling case should provide protection for the robotic platform from environmental conditions such as rain, water, dew, mud, and dust.

In some embodiments, the carrying case 14 is provided with handles for carrying it and to make it easier to throw. Either the handles or some other means, e.g. Velcro® strips, click buttons, or a special pouch can be provided for a quick connection to a vest or another garment of the user thus making it easy to carry while allowing quick deployment when necessary.

In addition, in some embodiments, carrying case 14 comprises windows 26 in the side walls that enable the imaging devices and sensors mounted on the robotic platform to gather information from within the case. The presence of the windows allows the robotic platform to take a look around its surroundings to determine if it is safe to exit the carrying case and allows useful, if perhaps limited information to be obtained if for some reason the robotic platform is unable to exit the case, e.g. the carrying case lands in deep mud that jams the opening or weather conditions or activity of the “enemy” make it imprudent or difficult to move through the area being surveyed. The windows 26 can be openings created in the walls of the carrying case, or may be transparent windows placed over the openings, or transparent sections of the walls themselves, providing that the windows or material of which the case is made are transparent to the energy detected by the imaging devices and sensors.

Once the case lands on the ground inside the desired observation area, the platform must be activated in order to exit the carrying case and to begin collecting information to send to the control station. While being carried to the site, the electric power supply of the platform is generally turned off to save energy and increase the mission time. Just before throwing the carrying case into the observation area the user must turn on the power supply. For the carrying case 14 shown in FIG. 2A, this requires removing one of the ends 30, partially sliding the robotic platform out of the case, manually turning on the power, closing the case back up, and then throwing it. This operation is greatly simplified using case 14′ shown in FIG. 2B. In this embodiment a lever 28, which protrudes through the wall of the case, is provided on the robotic platform to allow turning the power supply on or off without the necessity of opening the case. In an alternate arrangement the power supply of the robotic platform can be turned on or off by a signal from the remote command station.

In some embodiments, the case may comprise a communication unit and act as a relay station, relaying messages between the control station and the platform. This can be useful not only for the “start up” procedure, but also allows the case to function as a relay station when there are communication problems between the control station and the platform caused, for example by the robotic platform being located behind some obstacle that shields it preventing or weakening the signals to and from the control station.

In the embodiment of the carrying case shown in FIG. 2A, the case 14 comprises a central section 32 and two end sections 30 that are mechanically attached together by means of friction. When a signal is received from the control station, the robotic platform begins to move forward (or backward), pushes against one of the end sections 30 until the frictional force holding it to central section 32 of case 14 is overcome, the end section 30 becomes disconnected from the case, and the robotic platform exits the case beginning its travels through the observation area.

In the embodiment shown in FIG. 2B, case 14′ is comprised of two parts 34 and 36 mechanically connected to each other by friction. As in the embodiment just described, the force exerted by the moving platform is large enough to overcome the frictional force holding part 36 and part 34 together, allowing the robotic platform to exit the carrying case 14′ on command from the control station. It is to be noted that, particularly with embodiments that are similar in structure to carrying case 14 (FIG. 2A) the robotic platform can be returned back into the carrying case at any time; thereby taking advantage of the camouflage and protection provided by the case.

Referring to FIG. 1, the robotic platform 10 of the invention comprises a body 38, which is essentially a hollow box having a rectangular cross-section, with drive wheels 22 mounted on axles 42 at each corner of the box. The height of the rectangular box is kept as short as possible to keep the center of gravity of robotic platform 10 as low as possible, thereby increasing its stability. Removable covers 40 on both sides of body 38 allow access to the interior. The body 38 and wheels 22 of platform 10 are made of a material that has a high resistance to impact that is experienced on being deployed as described herein above or in collisions with obstacles, falls into ditches, tumbling down stairs, etc.

The drive sub-system of the robotic platform of the invention is comprised of the following main components: four wheels and at least one reversible electric motor and gear train.

The wheels 22 are made of soft or flexible material, e.g. rubber or polyurethane, to absorb the shock of impact with the ground and obstacles. The wheels slightly protrude in relation to the body of the platform, thus improving their ability to absorb shocks and protect the body 39 of the robotic platform and the devices attached to it. The outer surfaces of wheels 22 are convex as shown in the figure. Therefore, if the platform 10 tips onto its side while traveling, it will tend to right itself, i.e. fall until all four wheels are on the ground.

In preferred embodiments the driving system further comprises two tracks 20, one fitted tightly over the pair of drive wheels 22 on each side of robotic platform 10. Various arrangements well known to persons familiar with the design of tracked vehicles can be used to insure transmitting the power from the drive wheels to the tracks and also to prevent the tracks from sliding off of the wheels. In the embodiment shown in FIG. 1, the internal side of track 20 has a multitude of equi-spaced teeth 44 located on it. Teeth 44 fit into matching sockets (not shown in the figure) located in a groove 46 created around the circumference of each wheel. The tracks comprise a toothed outer surface to increase friction with the ground when in motion, thus improving the maneuverability of the robotic platform.

The third component of the driving system of robotic platform 10 is an electrical engine and gear train. The motor and gear train are located inside the body 38 of the platform. These are conventional components, well known in the art; therefore they are neither shown in the figures nor described herein. The motor and gear train are extremely quiet so as not to reveal the location of the platform as it moves around the observation area. The motor is reversible and therefore can cause the tracks to turn in either the clockwise or counterclockwise direction depending on the direction the robotic platform is to move. At a minimum, one motor can be used to turn either all four wheels 22 or one wheel on each side of the platform in order to cause the platform to move. Preferably the drive system comprises two motors, each one adapted to turn either one or both of the wheels that drive the belt on each side of the platform, will allow each track to be driven separately, not necessarily in the same direction, therefore resulting in much higher maneuverability. In another embodiment, four motors can be provided. This will not increase the maneuverability, but such redundancy will increase the reliability of the device at the expense of increased cost.

Located within the interior of body 38 of robotic platform 10 is a power supply and electric circuit that supplies DC electrical power to the motor/s that drive the robotic platform, the imaging assemblies, and additional sensors and components on the platform. The power supply is a battery package, which is easily accessible by removing one of the covers 40 of the body 38 to enable quick and easy replacement. The batteries can be replaced after every mission but in preferred embodiments they are rechargeable. For long missions or missions requiring more than the usual expenditure of energy, multiple battery packages can be placed inside body 38. As the charge in one package is depleted it can be replaced by a fully charged package either automatically or on command from the control station. Alternately, each of the energy packages can be connected to a different part of the circuit.

A communication assembly comprising a transmitter and a receiver for carrying out two-way communication with the remote control station and/or other robotic platforms is also located within the body of robotic platform 10.

In an embodiment of the present invention, the platform comprises a mechanism which enables the platform to be propelled forward, for the purpose of assisting the platform to overcome obstacles in its path. The mechanism can be based on springs or pyrotechnical means that will provide sufficient energy to propel the platform forward at an angle of 45° to cause it to “leap” over the obstacle, e.g. a ditch or pipeline. This feature is made possible by the symmetric design of the platform, which allows it to execute its mission properly irregardless of which side the platform lands on after the “leap”.

The main function of the robotic platform 10 of the invention is to provide images of its surroundings. To accomplish this purpose robotic platform 10 is equipped with at least four imaging sensors 48 (FIG. 1), one positioned on each side of the platform. Each sensor preferably has a horizontal field of view of at least 90° and a vertical field of view of at least 75°. Together the four imaging sensors enable viewing the entire space surrounding the platform. As shown in FIG. 1, the imaging sensors are indented in relation to the wheels 22 so that the wheels 22 and tracks 20 will protect them from receiving direct blows when the platform 10 is thrown and as the platform travels. Care is also taken in positioning imaging sensors 48 so that their range of view is not blocked by the wheels. Additional protection of the imaging sensors can be provided by fitting a transparent hard cover 54 over them as is shown in FIG. 1 for imaging sensor 52 (described hereinbelow).

Each of the imaging sensors 48 is a video camera comprising optics that allows the camera to obtain images having very wide fields of view. Lens such as those commonly known as fish-eye lens can be used but preferred embodiments of the robotic platform 10 make use of advanced lenses that are capable of providing omni-directional views of the surroundings. Typical lenses of this type are described, for example, in International Patent Application WO 03/026272 by the same applicant, the description of which, including publications referenced therein, is incorporated herein by reference.

In order to allow operation under any lighting conditions, robotic platform 10 is provided with illumination means. These means are conveniently provided as an array of light emitting diodes (LEDs) surrounding the objective lens of each imaging sensor. Depending on the mission, robotic platform 10 can be provided with imaging sensors capable of producing images in the UV, visible, NIR, or IR regions of the electromagnetic spectrum. The lighting means provided with each sensor are compatible to the sensitivity range of the specific imaging sensors used. The lighting means of the system may be a combination of different types of lighting means.

Preferred embodiments of the robotic platform comprise one or two additional imaging sensors 52 with zoom capabilities placed at the front/back of the platform to assist in navigation of the robotic platform, to provide close-up views for tracking of objects of interest detected in the wide-angle views, and for routine search and observation. In preferred embodiments of robotic platform 10, imaging sensor/s 52 is a video camera mounted on an electro mechanical mechanism of the PTZ (Pan Tilt Zoom) type which enables controlling the viewing angle. Sensor 52 is controlled by the user through the control station; however, it is also possible to program the computing means onboard the platform to implement automatic observation of predefined sectors as required. It is to be noted that the array of LEDs associated with imaging sensor 52 is mounted on the PTZ mechanism, which allows the array to be used for directional illumination.

The images gathered by the imaging sensors and data from other types of sensors located on the robotic platform 10 can be transmitted back to the control station where all the processing is carried out; however in preferred embodiments of the invention, onboard computing means comprising dedicated software and memory means are located within the interior of the body 38 of robotic platform 10. This allows at least a part of the data and image processing to be carried out and the results interpreted and converted to commands to the platform and/or components carried by it without the necessity of communicating with the control station.

Software is supplied, to the on-board computing means and/or to the control station, which uses well known techniques for processing the images and provides many different tools for using them. For example, the omni-directional views taken by the four imaging devices 48 can be stitched together into a panoramic image showing 360° around a vertical line drawn through the center of robotic platform 10. The images received can be processed by the use of an automatic Video Motion Detection (VMD) program. The use of VMD is well known to people skilled in the art. Preferred embodiments of the invention make use of advanced abilities of VMD including motion detecting in the omni directional images. As another example, either the onboard computing means or those of the control station can be given the means to sort objects in the images into general categories, for example people, animals, vehicles, etc. More sophisticated software enables identification of specific objects by comparison of the objects in the images with an existing database. Yet another option is to combine the image processing software with other software programs, e.g. Optical Character Recognition (OCR). This can be useful for various tasks, e.g. identification of license plate numbers.

In different embodiments many different types of sensors can be installed in the robotic platform of the invention. Examples of some types of sensors that can be attached to the platform are sound sensors, volume sensors, vibration sensors, temperature sensors, smoke detectors, NBC (nuclear, biological, chemical) sensors, moisture detectors, and carbon monoxide sensors.

In addition to providing data related to environmental and other conditions in the observation area, the sensors can be used to control, or to assist the user to control, the operation of the robotic platform. For example, the robotic platform and the imaging sensors on it can be in stand by mode with only a sound sensor 56, i.e. a microphone activated. When the microphone detects a noise, which can be any noise or a predetermined one, the omni-directional imaging sensors 48 and the VMD software on board robotic platform 10 are activated. If the VMD software detects motion, then the onboard communication means, including a transmitter and receiver, which enables sending information to and receiving operating commands from the control station is activated. The VMD information along with the images are transmitted to the control station and displayed on the display screen where the operator can decide upon an appropriate response. If the VMD software does not detect any motion, then after a predefined period of time, the system returns to stand by mode. This manner of operating the system is a very efficient method for reducing the consumption of energy, thereby enabling the platform to operate in the observation area for a substantial amount of time.

The use of two or more sensors can be very useful in helping to filter out false alarms. For example, if one type of sensor, e.g. a microphone, detects an occurrence, e.g. a sound similar to human footsteps, that should definitely have been detected by a different type of sensor, e.g. one of the imaging devices, and the second sensor does not send an image of a human, then the signal from the first sensor can, with a high degree of certainty, be considered to be a false alarm.

The software supplied with the computing means may include the feature of automatically processing data obtained from the different imaging sensors on the robotic platform for the purpose of giving recommendations and/or implementing automatic or semi automatic operations. For example, the combination of information provided by one or more of the imaging sensors and a volume sensor can indicate the presence of a person in the vicinity of the robotic platform. If the information indicates that the probability that the person detected is hostile is above a predetermined value, then a command can automatically be given to the platform to start to move towards the target to provide more detailed information. Alternatively, this feature can be semi-automatic i.e. the operator will be asked to approve the recommendations before they are implemented. Alternatively, only recommendations can be provided and the operator will be required to activate and navigate the platform according to his own judgment.

In embodiments of the invention, components, e.g. additional sensors, laser target marking systems, and even robotic arms to carry out tasks such as cutting tripwires connected to explosive devices can be paced on the upper surface of body 38 of the platform. In this case, the additional devices can be connected to the electric power supply and the onboard computing means by means of electrical contacts symbolically shown in FIG. 1 as socket 60.

Robotic platform 10 can also be used to carry devices such as communication support means for relaying information between two communication points, sensors for information gathering, and military equipment, e.g. anti-personnel mines, into the observation area and to distribute them at strategic locations, either predetermined or based on information gathered by robotic platform 10 during the mission. To enable this capability, all or part of the cover 40 of body 38 of platform 10 can be a magnet and the base of the “load” placed on it made of ferromagnetic material, in which case the forces caused by aggressively driving the robotic platform, e.g. alternating rapid starts and stops, quick changes of direction, etc., will overcome the magnetic forces and the load will fall off the platform. Alternately, all or part of cover 40 is an electromagnet and the load is released by shutting off the electricity supply to the electromagnet. In other embodiments, the load can be attached to cover 40 by mechanical means and released by a spring mechanism, an explosive charge, or any other method known in the art.

In embodiments in which components are attached to the outer surface of cover 40, the symmetry needed to allow the robot to be thrown or dropped into the observation area no longer exists. For example, if the platform comprises an externally mounted robotic arm and it landed with this side down, then the mechanism described herein above, which enables the platform to be propelled forward, can be activated to “flip over” the robotic platform. However, in some cases the asymmetry might be such that it is physically impossible to carry out maneuvers that would “flip over” the robotic platform and in other cases, e.g. the load is an explosive device, it is not safe to even try to turn the vehicle over. In addition, the externally mounted components might not be able to survive the impact of the landing after being thrown. Therefore in these cases, the robotic platform is operated in the conventional manner, i.e. placed on the ground outside of the observation area and driven inside to carry out its mission.

In embodiments of the robotic platform of the present invention, the platform 10 further comprises means that enable elevating different sensors, such as an imaging sensor or a microphone, or other components, e.g. antenna 58 or a loud speaker above the top surface of the body 38 of the platform in order to obtain a better range of coverage for gathering or transmitting information. Many types of suitable mechanism are known in the art, e.g. an electro mechanical mechanism similar to that used to raise and lower a car antenna.

In all embodiments of the present invention, communication to and from the robotic platform is wireless in order to allow maximum maneuverability. The two-way communication between the robotic platform and the remote control station can be either direct or via a relay station. The relay station can be an independent unit that is carried into the field on the robotic platform and dropped at an appropriate location or can be part of the carrying case. If a relay station is part of the carrying case than the link from the carrying case to the control station may be either wireless of through a communication cable. Any type of wireless communication technology known in the art can be used in the invention and the data can be transmitted in any form, e.g. digital, analog, encrypted, and compressed.

In the preferred embodiments of the invention, the management of instructions received from the control system and the method by which the data is received from the imaging and other sensors and transmitted to the control station is implemented by the processor in the body of the platform using multiplexing technology. The use of an on-board processor using multiplexing technology enables carrying out a number of sophisticated functions such as compressing data, encoding data, controlling the rate of data produced from each imaging sensor, synchronization between the cameras during transmission of the data, and managing the transmission of the data, all within a given bandwidth. Use of multiplexing technology allows the order of the transmission of the data from the imaging sensors to be easily determined and changed. For example, at the beginning of the mission, images from all of the imagers can be given equal importance and the images are transmitted in, for example a clockwise order. As the mission develops, one sector may become of more interest and the rate of transmission from the sensor/s aimed at that sector is increased at the expense of transmission of images from the imaging sensors that are aimed at sectors of less interest at that time. Each package of data transmitted is given an IP address allowing the receiver in the control station to reconstruct the data.

The remote control station 12 comprises a transmitter for transmitting commands and a receiver for receiving data from robotic platform 10. The control station comprises a processing unit with high processing capabilities that allows advanced image processing and information handling techniques and also relatively large memory means to allow storage of both raw and processed data and images. The remote station can be a dedicated unit or can be a standard device, such as a laptop PC or hand-held personal digital assistant, provided with appropriate software. The processing unit of the control station works in complete harmony with the on board processor of the robotic platform. In general the more complex tasks, which require larger resources for execution, are carried out at the control station and the simpler processing operations are executed by the processor in the platform itself. This division of usage of the processors in the system allows very efficient processing on the one hand and is also very power efficient, reducing considerably battery usage on the platform on the other hand.

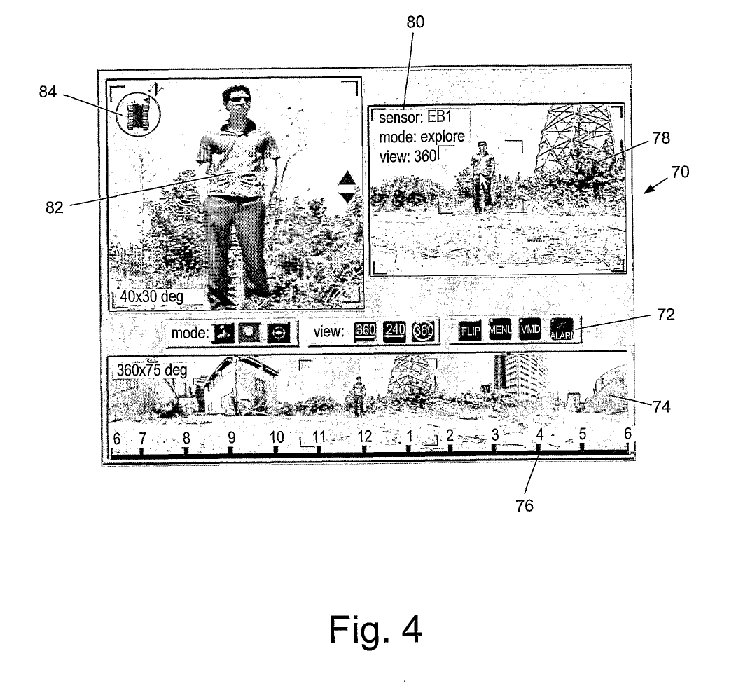

The control station also comprises a display screen for displaying the images and other information gathered by the sensors on the robotic platform. FIG. 4 shows one embodiment of the graphic user interface (GUI) 70 of the remote control station 12. Interface 70 is used for controlling and navigating robotic platform 10 by means of appropriate GUI buttons on control bar 72 and input means. The interface is preferably a touch screen, which allows the user to choose the manner of displaying the information from various options, depending on the requirements of the mission and his personal preference, simply by touching the appropriate icon on the screen.

The images transmitted from the imaging sensors on robotic platform 10 are displayed on interface 70 in a manner that can be very intuitively understood by the user. The processing unit of the control station comprises software that allows many image processing techniques to be executed to accomplish this goal. Omni directional images that arrive at the control station from the four imaging sensors 48 on the sides of the platform are seamlessly stitched together to form a single panoramic view displayed in window 74. This view shows the surroundings of the platform with a horizontal field of view of 360 degrees and, in this particular example, a vertical field of view of 75 degrees. To aid in the user a ruler 76 is provided, wherein the instantaneous direction directly in front of the robotic platform is designated 12 (o'clock) and the direction directly behind by 6 (o'clock).

If an object of interest is spotted in the panoramic image displayed in window 74, then an enlarged image from the image sensor that most clearly shows the object is displayed in window 78. The sector of the panoramic view to be displayed in window 70 can be chosen by the use of an input command or more simply by touching on the panoramic image with a finger. When the platform is moving, window 78 may be used to display the images from the front imaging sensor 48 at the front of platform 10 to aid the user in maneuvering the platform wisely, e.g. to help avoid obstacles or to choose a path that will reduce the chances of detection of the robotic platform. Additional information 80 is useful to the user, e.g. the identification of the imaging device that is transmitting the image, the operating mode of the platform (stationary, exploring, etc.), and the field of view, are also displayed in window 78.

If the platform carries a PTZ camera 52, then the images from this camera are displayed in window 82. This camera can be operated manually by the user, who sends commands from the control station, or automatically using the VMD mode. If there is no PTZ camera mounted on the robotic platform, then window 82 can be used to display electronically magnified areas of the image displayed in window 78. Shown in window 82 is a graphical display 84 for assisting the operator to understand the orientation of the platform in the field. The platform 10 comprises an on-board digital compass that transmits directional data to the control station 12. The data is processed at the control station information such as the direction that the platform is facing relative to north can be displayed. The graphical display 84 can also show the angle of the center of the field of view of the image from the PTZ imaging sensor shown in window 82 in relation to the platform.

By selecting the mode button on control bar 72, the user can move to another display mode, which enables display of operational data regarding the system. Typical information of this sort is the operational mode of the platform e.g. Active, Stand By, Ambush, Explore etc.; battery status; or the existence of a functional problem, e.g. one of the imaging sensors is not transmitting images or the platform is unable to move.

Embodiments of the robotic platform 10 comprise a system for self mapping, e.g. a digital compass and a GPS system. In these embodiments the processor of the remote control station enables displaying the exact point location of the platform on the GUI. The software in the processor enables other capabilities like the production and display of a graphical map showing, for example, the speed and direction of the platform or the boundaries of the observation area. In particularly important embodiments, the knowledge of the exact location and orientation of the robotic platform allows the integration of the images being transmitted from the observation area with images of the same area acquired on previous missions and stored in a data base or from other sources, such as aerial photographs. The integrated images can be displayed in many ways that will reveal information that is potentially even more valuable than that being gathered in the present mission, e.g. the aerial photographs can be used to help visualize more easily the spatial relationship between various objects seen from ground level, the aerial photographs can be used in real time to visualize what lies ahead and therefore help to navigate the robotic platform safely through the region of interest, and the images being gathered in the present mission can be overlaid (or vice versa) on previously obtained images to determine what, if any changes have taken place. Image recognition techniques can be applied to display only detected changes in the entire observation area or changes that have taken place in pre-selected regions or objects.

The GUI 70 of the control station 12, for example in the embodiment shown in FIG. 4, enables the display of the omni directional data in an intuitive visual manner that enables the user to easily choose the route and guide the robotic platform 10 along the desired path. The user can concentrate on the image in window 78 to see what lies directly ahead in his path while also glancing at the panoramic image in window 74 to get an overall picture of what is happening and to use this information to decide if he should change direction in order to investigate an interesting object or to chose an easier route to traverse. Navigational instructions can be given to the robotic platform by means of conventional means such as a joy stick, GUI buttons, of a mouse.

In preferred embodiments the display screen/GUI is a touch screen and the user merely has to touch the screen in one of the displayed images 74,78 to indicate the direction in which he wants the platform to move. The software in the processor of the remote control station automatically converts the touch on the screen into commands that are sent to the mobile platform to control the drive motors and steer the platform. With a geographical map displayed on the touch screen, the user only needs to touch a location on the map. The processor calculates the azimuth and distance from the present location and orientation of the robotic platform and transmits commands to change the direction of the platform to face the selected location. An additional command is sent to the platform instructing it either to send images of the selected location or to begin traveling towards it according to the choice of the user. The user can mark out a more complicated route by touching several spots on the map. The control station will then send commands to the mobile platform, which will “follow the dots” to travel the desired route. Previously sent commands can be overridden by the user and new ones sent instantaneously by use of the touch screen.

In the embodiments of the invention in which the robotic platform comprises a GPS system, the GPS image data is transmitted to the control station thus allowing the location of the platform to be displayed. The GPS system makes it possible to preprogram a route for the platform either before it is thrown into the observation area or the route can be transmitted to the platform during its mission. In this embodiment a top view or a topographical map of the observation area can be displayed with a marker showing the exact location of the platform and other information, e.g. velocity and projected remaining operational life-time of the batteries, at all times.

In an urban environment the GPS system capabilities can be very limited. In addition there are low cost transmitters capable of disrupting the GPS long range signals such that the GPS system can not always be reliable. The present invention enables a technique for viewing the location of the platform and tracking the platform without using the GPS system. The details of the technique can be found in International Patent Application WO2006/043270 by the same applicant, the description of which, including publications referenced therein, is incorporated herein by reference. In this technique the software enables the sky lines in the images taken by the omni directional imaging sensors to be recognized and compared with a prepared sky line database thus being able to calculate the location of the platform with the accuracy of just a few centimeters.

Using the generated maps and other techniques described herein enables the user to transmit automatic navigation commands to a robotic platform to follow the route of another platform that has previously driven the same route. This is a mode of operation known as Follow the Leader (FTL).

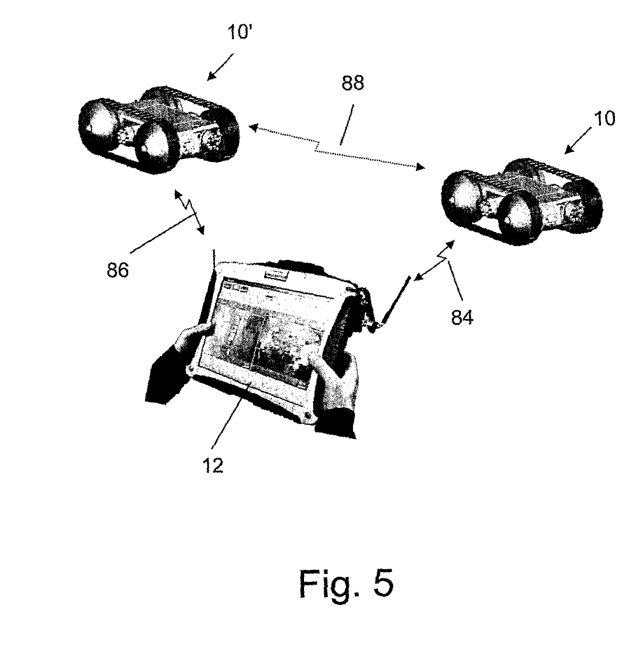

FIG. 5 schematically shows an embodiment of the present invention in which the user controls two or more platforms using one control station. Each robotic platform 10 and 10′ can communicate independently with control station 12 by means of a wireless link 84,86 as described hereinabove. Platforms 10 and 10′ can also communicate between each other. The communication link 88 between the two platforms can be based on directional IR communication technology in order to minimize the chances of detection during a mission. This provides a redundancy in the communications network that can allow for communication with both platforms even if one of them is in a “dead zone” as far as direct communication with the remote station is concerned. Also the existence of alternative communication routes can be utilized to maximize the efficiency of power consumption or in case of equipment failure.

The use of several robotic platforms in the same observation area can provide many operational advantages over the use of a single platform. For example, The user can combine the capabilities of the platforms to work together in a synergetic manner in order to, for example set up the platforms for an ambush, cover a wider area of observation, or to use certain sensors on one platform and other types of sensors on the other, thereby increasing the types of information that can be collected in the observation area. As another example of the benefit of using multiple platforms, if a suspicious sound or motion is detected, one of the robotic platforms can be sent to investigate and at the same time the other/s can continue exploring the observation area. Another advantage is that the length of the mission can be prolonged by activating the sensors on only one of the platforms at a time while the other either blindly follows in the FTL mode while its sensors are in a sleep mode or alternatively, the second platform can shut down entirely, until the first platform uses up its available power, at which point, the first platform shuts down and the second one is awakened by a signal from either the other platform or the control station and takes over the mission.

Division of the tasks between platforms can be automatic; semi automatic, i.e., based on a recommendation made by the system to the user for his approval; or the user can manually give commands for each of the operations. To make possible the automatic and semi-automatic modes, a software program is installed in the processors of the robotic platforms.

The software makes it possible to define one of the platforms as a commander platform which gives commands to the other platforms and divides the mission tasks between them. In the automatic mode the system user transmits a command to execute a mission. The commander platform receives this command, processes it, implements part of the mission, and sends operating commands to the other platforms to complete the mission. In the semi-automatic mode, the commander platform analysis the mission requirements; devises a plan based upon, amongst other things on the capabilities of each of the platforms and their locations; and sends the plan to the user for either approval or modification before it is executed.

As in the case of a single platform the processor in the remote control station can process the images and other data received from the two or more robotic platforms on a GUI. Different display options are available including displaying panoramic images and enlarged images from all of the platforms simultaneously or scrolling between different windows. The control station can show images from one platform on half of the display screen and images from the other platform on the other half of the display screen, and can enlarge one image at the expense of the other if desired.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A remote controlled robotic platform outfitted for gathering information from a hostile or dangerous environment and transmitting said information to a remote control station, said robotic platform comprising:
a) a body, comprising a hollow box;
b) at least four imaging assemblies at least one of which is located on each side of said body;
c) one or more additional sensors;
d) a communication assembly comprising a transmitter and a receiver;
e) onboard computing means comprising dedicated software and memory means;
f) a drive sub-system comprising four drive wheels, at least one reversible electric motor, and a gear train; and
g) a power supply for supplying DC electrical power to the components of said robotic platform;
h) wherein said robotic platform is designed and built to enable it to be thrown or dropped into said hostile or dangerous environment.

2. A robotic platform according to claim 1, wherein the drive sub-system comprises two tracks, each track fitted tightly over the pair of drive wheels on one side of said robotic platform.

3. A robotic platform according to claim 1, wherein the additional sensors are selected from the group comprising:
a) video cameras mounted on PTZ mechanisms;
b) sound sensors;
c) volume sensors;
d) vibration sensors;
e) temperature sensors;
f) smoke detectors;
g) NBC (nuclear, biological, chemical) sensors;
h) moisture detectors, and
i) carbon monoxide sensors.

4. A robotic platform according to claim 1, comprising one or more of the following components:
a) illumination means;
b) laser target marking system;
c) robotic arm;
d) elevating means that enable elevating sensors above the top surface of the body of said platform;
e) digital compass; and
f) GPS system.

5. A robotic platform according to claim 1, wherein the symmetry of said robotic platform, including the placement of imaging devices and sensors, enables said robotic platform to perform its mission with either side up.

6. A robotic platform according to claim 1, wherein said platform comprises a mechanism which enables the platform to be propelled forward, for the purpose of assisting the platform to overcome obstacles in its path.

7. A robotic platform according to claim 1, wherein the onboard computing means is configured to use multiplexing technology to handle the data received from the sensors and communication too and from said platform.

8. A system for gathering information from a hostile or dangerous environment, said system comprising:
a) one or more robotic platforms according to claim 1;
b) one carrying case for each of said robotic platforms; and
c) a remote control station.

9. A system according to claim 8, wherein the carrying case is adapted to:
a) make it easy to carry while traveling to the site of the mission;
b) to protect the robotic platform while traveling to the site of the mission;
c) to be easily thrown into the observation area; and
d) to protect said robotic platform from damage caused by impact with the ground or other objects when thrown into said observation area.

10. A system according to claim 8, wherein the carrying case comprises a communication unit, which acts as a relay station, relaying messages between the remote control station and the robotic platform.

11. A system according to claim 8, wherein the remote control station comprises:
a) a transmitter for transmitting commands;
b) a receiver for receiving data from the robotic platform;
c) a processing unit;
d) software that enables advanced image processing and information handling techniques;
e) memory means to allow storage of both raw and processed data and images; and
f) a display screen for displaying the images and other information gathered by the sensors on the robotic platform.

12. A system according to claim 8, wherein the processing unit of the control station and the on board processor of the robotic platform are configured to work in complete harmony.

13. A system according to claim 8, wherein the processing unit of the remote control station and the on board processor of the robotic platform are supplied with software that enables some or all of the following capabilities:
a) stitching together the views taken by the four imaging devices into an Omni-directional image;
b) processing images by the use of an automatic Video Motion Detection (VMD) program;
c) the ability to sort objects in the images into general categories;
d) the ability to identify specific objects by comparison of the objects in the images with an existing database;
e) the ability to combine the image processing software with Optical Character Recognition (OCR);
f) the ability to recognize the sky lines in the images taken by the imaging sensors to compare them with a prepared sky line database thus being able to calculate the location of the platform; and
g) the ability to control two or more robotic platforms using one remote control station.

14. A system according to claim 8, wherein the display screen is a graphic user interface (GUI) configured to enable the user to control and navigate the robotic platform by means of appropriate GUI buttons on a control bar and input means.

15. A system according to claim 14, wherein the interface is preferably a touch screen, configured to allow the user to:
a) choose the manner of displaying the information from various options, depending on the requirements of the mission and his personal preference, simply by touching the appropriate icon on the screen; and
b) to plan the mission and navigate the robotic platform simply by touching locations of interest in the images displayed on said interface.

16. A system according to claim 15, wherein the images displayed on the touch screen are one or more of the following:
a) real time images from the observation area;
b) real time images from the observation area integrated with images from previous missions in the same area;
c) aerial photographs of the observation area;
d) real time images integrated with aerial photographs of the observation area;
e) graphical maps; and
f) topographical maps.

17. A system according to claim 8, wherein the remote station is one of the following:
a) a dedicated unit;
b) a laptop PC; or
c) hand-held personal digital assistant.

18. A method of using the system of claim 8 for gathering information from a hostile or dangerous environment, said method comprising the steps of:
a) placing a robotic platform according to claim 1 into a carrying case;
b) carrying said carrying case to the boundary of said environment;
c) throwing said carrying case into said environment;
d) activating the drive sub-system of said robotic platform to drive said robotic platform out of said carrying case;
e) activating the imaging sensors and other sensors on said robotic platform to gather said information while navigating said robotic platform along a chosen path within said environment.
